(19) United States
(12) Patent Application Publication
(10) Pub. No.: US 2017/0217047 A1
(43) Pub. Date: Aug. 3, 2017

(54) Self-Cleaning Concrete Mix Monitoring

(71) Applicant: GCP Applied Technologies Inc., Cambridge, MA (US)

(72) Inventors: Craig K. Leon, Acton, MA (US); Kati Hazrati, Concord, MA (US); Nathan A. Tregger, Northborough, MA (US); Eric P. Koehler, Miami Beach, FL (US); Tuan Hoang, Milford, OH (US); Mark F. Roberts, North Andover, MA (US)

(21) Appl. No.: 15/328,748

(22) PCT Filed: Jul. 24, 2015
(86) PCT No.: PCT/US15/41969

§ 371 Date: Jan. 24, 2017

Related U.S. Application Data
(60) Provisional application No. 62/028,645, filed on Jul. 24, 2014.

(51) Int. Cl. B28C 5/42; B28C 7/12; B28C 7/02

(52) U.S. Cl. CPC B28C 5/422; B28C 5/4231; B28C 7/024; B28C 7/128

(57) ABSTRACT

System and method of the invention involves use of a sensor-containing body which is mounted and/or rotatably disposed along the longitudinal rotational axis of a concrete mixer drum at the close end, the sensor-containing body being connected to a conduit for introducing water, chemical admixture, gas, and/or cleansing fluid through the closed end of the drum into the mixer drum. Numerous heretofore unrealized combinations of advantages and benefits are provided within the concrete industry by the invention.

### TECHNICAL FIELD

The present disclosure relates to processing of concrete mixes, and more particularly to a system and method for monitoring one or more properties of a concrete, mortar, or other material contained in a rotating mixer container.

### BACKGROUND

Automated systems are used for mixing concrete mixes contained in ready-mix delivery trucks. Such automated systems measure energy required for mixing a concrete load contained in a rotatable mixer drum, or otherwise measure the force or pressure imposed by the concrete upon an electromechanical sensor located within the drum, to ensure that slump or workability of the concrete during transport or at delivery are within a desired range.

Concrete mixer drums, as seen on ready-mix delivery trucks on the roads today, are not purely geometrical cylinders that rotate in a parallel or perpendicular direction with respect to the ground. While sometimes described as generally cylindrical in nature, such mixer drums are more accurately described as having irregular pear-like shapes, with inner walls that are somewhat angled with respect to horizontal ground, and upon these inner walls are mounted two or more blades which are spirally-oriented around the rotational axis of the mixer drum, which is slanted between 10-20 degrees with respect to horizontal ground. The concrete mix is pushed (downwards at a slant) towards a more bulbous and closed end when the mixer drum is rotated in one direction; or otherwise discharged (upwards at a slant) towards and through the drum opening located at the other (less bulbous) end when the drum is rotated in the opposite direction.

Automated systems for monitoring the concrete within the mixer drum during transit are by now well known, and are of two basic types. One involves measuring the energy or hydraulic pressure required to rotate the concrete mixer drum, and the other involves the use of electromechanical probe or sensor to measure the force or pressure of the concrete directly within the drum. The first kind which involves primarily the use of hydraulic pressure monitoring is commercially available from Verifi LLC of Ohio and is described generally in patent literature authored by Verifi LLC (e.g., U.S. Pat. No. 8,118,473 of Compton et al.; U.S. Pat. No. 8,020,431 of Cooley et al.; U.S. Pat. No. 8,491,717 of Koehler et al.; U.S. Pat. No. 8,118,473 of Cooley et al.; U.S. Pat. No. 8,989,905 of Sostaric et al.; and U.S. Pat. No. 8,881,8561 of Koehler et al., all of which are incorporated by reference herein). The second kind, which involves primarily the use of probes or other electromechanical sensor for sensing the force or pressure applied by concrete on the sensor, is disclosed in WO2011/042880 A1 and US Publication No. 2012/0204625 A1 (application Ser. No. 13/500,643), of Beaupre et al. (assigned to I.B.B. Rheologie Inc.); US Publ. No. 2011/0077778 A1 and WO2009/144523 of Bertold Berman (assigned to Dully Katzeff-Berman); and European Patent Application No. EP 1 961 538 A2 of Eugenio Bonilla Benegas (Application No. 06847054.1).

For example, WO 2011/042880 of Berman discloses the use of a probe which is mounted upon an inner side wall of the rotating mixer drum. The present inventors believe that some of the disadvantages of such a probe include the fact that it is rotated at the extreme circumference of the inner drum diameter and repeatedly subjected, upon each single rotation of the drum, to the sheer forces of the concrete slurry, which contains the coarse gravel or crushed stone aggregates. Moreover, when the drum is rotated such that the probe is revolved out of and above the concrete which resides toward the lower wall of the drum, the cement within the concrete can begin to accumulate on the sensor.

In view of these potential disadvantages, the present inventors believe that a novel and inventive concrete monitoring probe and system are needed.

### SUMMARY

The present disclosure provides a system and method which employs a sensor-containing body which is mounted and/or rotatably positioned within and along the longitudinal rotational axis of a concrete mixer drum and which further comprises a conduit for introducing water, chemical admixture, gas, and/or purging or cleaning fluids into the drum through the closed end of the drum.

Numerous advantages and benefits are provided by this inventive approach. The sensor-containing body can be outfitted with sensors for monitoring yield stress, viscosity, slump, slump flow, or other rheological properties of concrete contained within the drum, while at the same time allowing for injection of materials into the concrete and mixer drum, for the purpose of treating the concrete, (self-cleaning) the sensor-containing body, and for cleaning the inner walls and mixing blades within the drum.

Unlike prior art designs which require the probe to be rotated periodically into and out of the concrete at the outermost circumference within the rotating drum belly, the axial location of the sensor-containing body in the present invention minimizes the incessant impacts of stone aggregates being tumbled and churned within the rotated concrete mix.

Further exemplary sensor-containing bodies can also be rotatably connected to one or more other bodies which contain sensors and/or nozzle devices which are fixedly positioned about or which rotate about the longitudinal rotational axis of the concrete mixer drum. Thus, it is possible to use nozzles, which may fixedly mounted or rotatably mounted in the manner of a high pressure rotating sprinkler, for cleaning the inside of the drum cavity, using water, set retarding mixture, or other liquid.

Such axial-located or -disposed bodies can allow for the concrete mix to be aerated (if necessary) and also be used for spraying fluids (such as liquid set retarders) against the drum inner wall and mixing blades for cleansing purposes.

The use of a conduit for passing water, chemical admixtures, gas (e.g., air, carbon dioxide), or cleaning fluid (which could be a combination of water and set retarder admixture) through the closed end of the mixer drum permits all-season delivery of concrete in truck mixer drums, as this avoids having to insulate and to heat pipes and hoses which would otherwise be run outside of the drum and upwards into the opening of the drum.

The conduit and sensor-containing body can also be used for dispersing a gas into the mix, such as carbon dioxide, which can be used to strengthen the concrete.

Thus, an exemplary system of the present invention for monitoring contents within a rotatable concrete mixer drum, comprises: a sensor-containing body which is fixedly mounted and/or rotatably positioned within and along the longitudinal rotational axis of a concrete mixer drum having a closed end and an open end, and which sensor-containing body is connected to a conduit which introduces water, chemical admixture, other liquid (e.g., liquid nitrogen), gas (e.g., air, carbon dioxide), and/or purging or cleaning fluid into the concrete mixer drum through the closed end of the drum; the sensor-containing body having at least one channel for delivering the water, chemical admixture, other liquid, gas, and/or purging or cleaning fluid from the conduit and into the concrete mixer drum. In further embodiments, the sensor-containing body is mounted to an inner wall of the concrete mixer drum or to a plate mounted upon the inner wall at the closed end of the drum. In still further embodiments, the sensor-containing body is rotatable mounted such that it may rotate at a different rotational rate compared to the rotation of the concrete mixer drum.

Methods for monitoring concrete involve the use of the above-described system, and are particularly suitable for monitoring and adjusting concrete during transit or delivery.

Further advantages and features of the present disclosure are described in further detail hereinafter.

### BRIEF DESCRIPTION OF DRAWINGS

An appreciation of the benefits and features of the present disclosure may be more readily comprehended by considering the following written description of preferred embodiments in conjunction with the drawings, wherein

FIG. 1 is a plan diagram view of an exemplary system and method of the invention comprising at least one sensor-containing body that is mounted and/or rotatably positioned within and along the longitudinal rotational axis (designated at A) of a concrete mixer drum and further comprising a conduit for introducing water, chemical admixture, and/or gas into the drum through the closed end of the drum;

FIG. 2 is an enlarged view of an exemplary sensor-containing body mounted and/or rotatably positioned within the concrete mixer drum, showing exemplary conduits or pipes within the housing of the sensor-containing body for passing water, chemical admixture, gas, and/or purging liquid introduced by way of the conduit into the mixer drum;

FIG. 3 is an enlarged view of an exemplary one-way valve which can be used on the sensor-containing body to direct water, chemical admixture, gas, and/or purging fluid along the outer surface of the sensor-containing body to clean or purge the outer surface of the sensor-containing body from build-up from concrete or other cementitious composition within the mixer drum;

FIG. 4 is an enlarged view of another exemplary sensor-containing body mounted and/or rotatably positioned within the concrete mixer drum, wherein an elongate member on the sensor-containing body is shown positioned further below the rotational axis (A) for sensing rheology of concrete that accumulates at the lowest levels of the drum; and

FIG. 5 is a perspective view taken along the longitudinal rotational axis (A) of another exemplary sensor-containing body of the present invention wherein one or more sensors can be located within the housing of the sensor-containing body, and openings in the sensor-containing body admit concrete or cement within the housing for measuring or monitoring purposes; and

FIGS. 6A and 6B are cross-sectional diagrams of an exemplary sensor-containing body taken, respectively, along the mixer drum rotational axis (FIG. 6A) and perpendicular to the rotational axis (FIG. 6B), wherein an elongate channel is defined between two openings within the sensor-containing body to admit passage of concrete through the sensor-containing body upon rotation of the body, such that, for example, a sonar emitter and sonar detector (and/or other sensor or sensors) can be spaced apart along the elongated channel for the purposes of obtaining a sonar profile (and/or monitoring other property) of the concrete within the channel;

FIG. 7 is a cross-sectional diagram of an exemplary sensor-containing body taken along the mixer drum axis of rotation, illustrating an exemplary inlet flap for directing concrete into a channel and an exemplary outlet flap for facilitating exit of concrete from the channel;

FIGS. 8-10 are diagrams of exemplary sensor-containing bodies having outer ribs, vanes, and/or offset flanges, illustrated in a perspective along the mixer drum rotational axis (A), for increasing shearing forces within the concrete mix contained within the mixer drum; and

FIG. 11 is a diagram of a cross-section, illustrated in a perspective perpendicular to the rotational axis (A), of another exemplary sensor-containing body that is mounted by a brace or support (to frame or other fixed structure on delivery truck not shown) to prevent rotation of the sensor-containing body when the mixer drum is rotated.

### DETAILED DESCRIPTION OF PREFERRED EMBODIMENTS

The present invention now will be described more fully hereinafter with reference to the accompanying drawings, in which various exemplary embodiments are shown illustrating variations within the scope of the invention. This disclosure may, however, be embodied in many different forms and should not be construed as limited to the embodiments set forth herein; rather, these embodiments are provided so that this disclosure will be thorough and complete, and will fully convey the scope of the disclosure to those of ordinary skill in the art.

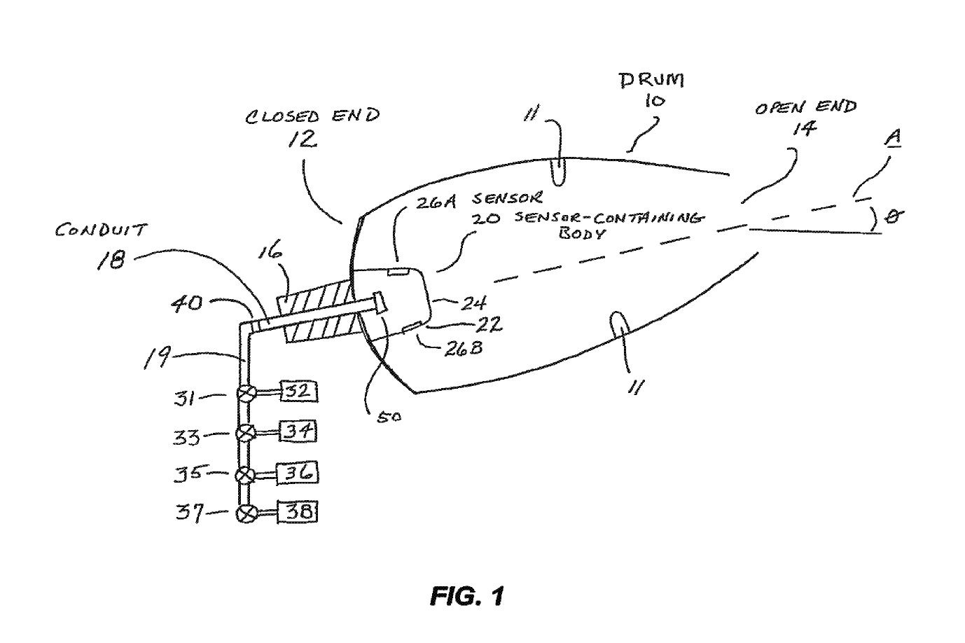

FIG. 1 illustrates an exemplary embodiment of the present invention wherein a mixing system, such as found on a concrete mixer delivery truck, comprises a rotatable mixer drum 10 driven by a motor such as a hydraulic pressure or electric drive (not shown). On concrete mix delivery trucks, the hydraulic pressure drive is configured to cause the drum 10 to rotate in a first direction, causing the contents of the drum 10 to be driven towards the closed end 12 of the drum to be mixed, or in a second direction opposite the first direction, with spirally-mounted blades 11 or paddles mounted on the inner wall of the drum 10, causing the contents of the drum 10 to discharge out of the mixer drum opening 14. At the closed end 12 of the mixer drum 10, the drum is fitted to the delivery truck using a solid axle or transmission gear assembly (both of which are generally depicted and designated as at 16). The longitudinal axis of rotation of the drum is designated at “A” and is typically found on mixing trucks oriented at an angle (Ø) of 10-20 degrees or more with respect to horizontal ground.

An exemplary system and method of the invention, as shown in FIG. 1, involve the use of a sensor-containing body 20 which is (a) mounted and/or rotatably positioned along the longitudinal axis of rotation (designated at “A”) of the drum 10; (b) located at or adjacent to the closed end 12 of the drum 10; and (c) sealably connected to at least one conduit 18 (e.g., pipe or hose) which conveys water, chemical admixture, other liquid (e.g., liquid nitrogen), gas (e.g., air, carbon dioxide), liquid (e.g., liquid nitrogen) and/or purging liquid through the closed end 12 of the drum 10 and into the mixer drum 10 cavity preferably through the sensor-containing body 20. Further exemplary embodiments thus comprise at least two sources of gas, liquid, or both. One or more pipes may be connected through the conduit to one-way nozzle or check valve (which allows for injection under pressure of liquid or gas) into the concrete mix contained in the mixer drum 10 by means of the sensor-containing body 20. The term “conduit” may be used to denote a pipe, pipes, or channels through which materials can be conveyed, or through which wires or supportive structures may be passed, from outside of the mixer drum 10 into the inside of the drum, as will be further described and illustrated herein.

Thus, in the exemplary embodiment shown in FIG. 1, the conduit 18 may be used for introducing into the cavity of the mixer drum 10 one or more of the following components or materials: e.g., water 32; one or more chemical admixtures 34 (e.g., a plasticizer or dispersant, air entraining and/or air detraining admixtures, set retarding admixture, set accelerating admixture, corrosion inhibiting admixture, strength enhancing admixture, crack control admixture, water permeability enhancing admixture, and mixtures thereof); a gas 36 (e.g., air, carbon dioxide, and mixtures thereof); and/or purging or cleaning liquids (e.g., which could be a combination of water and set-retarding admixture). These can be introduced into the mixer drum 10 through the conduit 18 using appropriate valves, examples of which are generally illustrated as at 31, 33, 35, and 37.

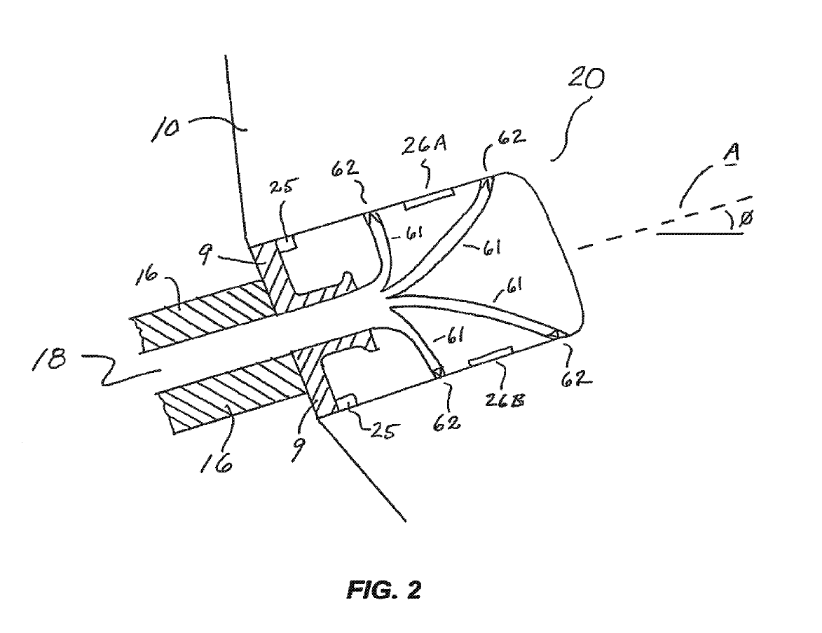

The exemplary sensor-containing body 20 is illustrated in the side perspective plan view of FIG. 1 as having generally a “bucket” or generally conical or generally cylindrical circumferential outer face 22 whose diameter is evenly spaced from the longitudinal rotational axis of the drum (designated at A) and a flat outer face 24. Other exemplary sensor-containing body 20 shapes could also include a “test tube” shape (note shown) having an outer face 24 which is more hemispherical in shape. A variety of shapes can be used for the sensor-containing body 20 which contains at least one sensor 26, such as cylindrical, conical or frusto-conical (e.g., bucklet-like), spherical or hemispherical, or combinations thereof. Two sensors are designated at locations 26A and 26B which are used for measuring the force or pressure exerted by a concrete mix contained within the mixer drum 10. These electromechanical sensors, which can be stress gauges or strain gauges, can be connected by wires (not shown) that can be run through the conduit 18 to a computer processing unit (not shown) located outside the mixer drum 10, or can be connected to transmitter units for wireless communication to the computer processing unit, which is configured and/or programmed to calculate slump of the concrete based on the sensor output. This electromechanical sensor system design is used in combination with probes, fins, blades, and other shapes which project into the concrete or are otherwise deformable by the pressure of the concrete being moved within the rotating mixer drum 10. So-called strain or stress gauges have been known over 75 years and typically consist of a flexible insulative backing material which supports a metallic foil pattern; as the object is deformed, the foil is deformed, causing its electrical resistance to change. Thus, the strain gauge sensors (e.g., 26A, 26B), which may otherwise be referred to herein as force sensors, may be embedded within flexible probes, fins, blades, or other shapes (not shown) at locations 26A and 26B shown in FIGS. 1-2, or may be mounted upon or embedded within a flexible portion of an outer, or, more preferably, inner wall surface of the sensor-containing body 20).

The housing of the sensor-containing body 20 can be made of stainless steel, brass, polymer, or other materials which are sufficiently durable to withstand the rigors of concrete mixing. The force sensors 26 may be located at openings (not shown) in the wall of the sensor body 20 and may be made of the materials usually employed for contact with the concrete, mortar, or other materials being mixed within the mixer drum.

The conduit 18 may be connected to a base plate (not shown) mounted on the inner face of the drum such that it rotates along with the drum while delivering water, chemical admixture, gas, and/or purging liquid into the sensor-containing body 20, or it may be sealably connected such as by using a gasket 50 (as designated in FIG. 1) for delivering the water 32, chemical admixture 34, gas 36, and/or purging liquid 38 or other liquid into the sensor-containing body 20. As shown in FIG. 1, the conduit 18 may be connected at each end using one or more annular-shaped gaskets 40/50 which could allow the conduit to move rotationally while still providing a seal with hose or pipe 19 used for conveying the water 32, chemical admixture 34, gas 36, and/or purging liquid 38 into the sensor-containing body 20. If not mounted to the inner wall of the mixer drum or to a plate or other structure that is mounted to the inner wall of the mixer drum, the sensor-containing body 20 may be rotatably mounted such as about a spindle or other structure, such that the sensor-containing body 20 can move at the same or different speed with respect to the rotation of the mixer drum 10.

The conduit 18, pipe 19, axle 16, or all or a combination of these can be connected to a heating unit, such as heating filaments, to ensure that no liquid pumped through the conduit 18 will be frozen during cold months.

As shown in FIG. 2, an exemplary sensor-containing body 20, having a generally cylindrical shape, but this time with a somewhat slightly rounded distal end, is shown rotatably positioned within the concrete mixer drum 10 and connected to the conduit 18 or pipe which passes through an axle 16 member and into the sensor-containing body 20, so that water, chemical admixture, gas, and/or purging liquid can be pumped into the mixer drum 10 cavity.

In this exemplary embodiment, the sensor-containing body 20 is shown rotatably attached to a plate 9 mounted on the inner drum wall to which the conduit 18 is connected (such as by soldering or gluing the conduit 18 (or using a gasket or sealing grommet which is not shown) to the plate 9. The sensor-containing body 20 rotates about the rotational axis of the drum slidably and sealingly against the plate 9 by means of an annular gasket 25 which prevents leakage of liquid or concrete into the sensor-containing body 20. Within the sensor-containing body 20 are one or more channels or pipes 61 leading to one way nozzles (designated at 62) for conveying the water, chemical admixture, gas, and/or purging liquid through the sensor-containing body 20 and into the cavity of the mixer drum 10.

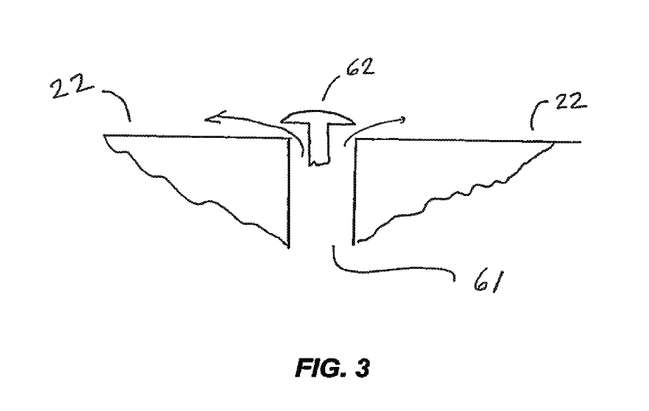

The openings (designated as at 62) at the outer surface of the sensor-containing body 20 use one-way (check) valves to permit liquids or gas to be expelled under pressure from the sensor-containing body 20 while preventing the ingress of concrete, liquids, or aggregates from the mixer drum 10 cavity. More preferably, the check valves 62 that are made of metal (e.g., brass, stainless steel) to withstand the pressure of concrete loads. Spring-loaded ball type check valves are perhaps most preferred for high volume introduction of liquids as these can be used in higher diameters; although tappet type valves (as suggested in FIG. 3) are also believed to be useful for the present application. It is believed by the present inventors that selection of efficient one-way valves would be within the knowledge of those skilled in concrete equipment engineering. For example, small diameter nozzle type injectors are used advantageously to inject atomized mists into diesel engine combustion chambers, and concrete slurries would present far less of a challenge compared to combustion chambers.

One-way valves should be used to permit water, chemical admixture, gas, and/or purging liquid to be introduced into the mixer drum cavity through the housing of the sensor-containing body 20 without allowing concrete, cement, or aggregate, or other material to seep back into the housing or channels therein. An elastomeric material such as silicon or butyl rubber can be used as a one-way out gasket which is tightly secured tightly within the channel within the housing. A one-way out gasket may be formed by having a hole that allows for passage of gas or fluid once a certain minimum positive pressure level is reached. The shape of the hole, for example, could be somewhat conical in shape so that pressure within the channel can be used to open passage through the gasket. Pressure may be generated using a positive pressure pump for conveying the water 32, chemical admixture 34, gas 36, and/or purging liquid 38 into the sensor-containing body 20.

One-way out valves can be metal nozzles over which protective flaps can be used to prevent plugging by concrete or other cementitious material. It is possible that extremely high pressures (e.g., 50-200 psi) can be used for spraying water or water with set retarder admixture against the inner drum wall and mixing fins to achieve quick and effective internal cleaning of the drum.

As shown in FIG. 3, an exemplary one-way valve 62 which can be used on the sensor-containing body to direct water, chemical admixture, gas, and/or purging fluid along the outer surface of the sensor-containing body 20 to clean or purge its outer surface from build-up from concrete or other cementitious composition. The valve 62 can be shaped to direct flow of effluent material in any desired direction (and can be physically attached into an otherwise closed position in the absence of pressure by any known means).

It is envisioned that a combination of various types of one-way valves can be used. For example, a number of pinch type or spring/ball one-way out valves or nozzles can be positioned over the outer surface of the sensor-containing body 20 so that highly pressurized water (or a combination of water and set retarder) can be sprayed against the inner surface and mixing blades in conventional mixer drums to wash the surface, while at the same time the valves shown in FIG. 3 can be used to maintain cleanliness of the outer surface of the sensor-containing body 20. Although not specifically illustrated in FIG. 3, it would be understood that the tappet-style check valve 62 should have a shape that is conformed to the shape of the opening such that it is firmly, supportively seated in the closed position and not easily dislodged by concrete being mixed within the drum. The head of the tappet-style check valve could have an umbrella or fluted shape to better direct liquids laterally along the outer surface of the sensor-containing body housing 20 to prevent concrete from sticking to the outer surface.

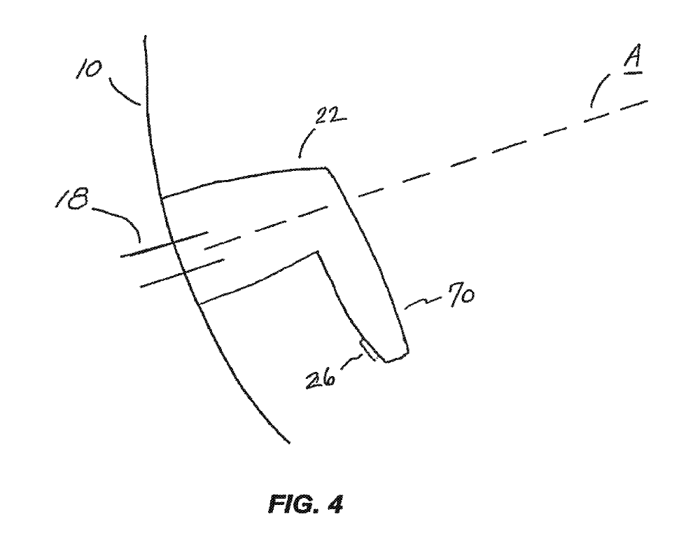

FIG. 4 illustrates another exemplary sensor-containing body 22 mounted and/or rotatably positioned within the concrete mixer drum 10, wherein an elongate member 70 on the sensor-containing body is shown positioned further below the rotational axis (A) and having at least one electromechanical force sensor 26 for sensing a rheological property of concrete that accumulates at the lowest levels of the drum 10. In further exemplary embodiments, the sensor-containing body 22 and/or the elongate member 70 may have at least two force sensors. For example, when the drum 10 or sensor-containing body 22 is rotated, a first force sensor embedded within the elongate member 70 is effective for measuring force of the concrete in a direction perpendicular to the rotational axis (A), while a second force sensor also embedded within the elongate member 70 is effective for measuring force of concrete in a direction parallel with the rotational axis (A). In still further exemplary embodiments, a bi-axial strain gauge (26) may be used upon or within the elongate member 70 to measure forces of the concrete in two planes. It is surmised by the present inventors that, due to the swirling action of the concrete in the mixer drum as the concrete is being rotated and also pushed towards the closed end of the drum by spirally-mounted mixer blades, the use of two force sensors or a bi-axial sensor will provide useful data that can be used to correlate force of the concrete with physical properties such as slump, slump flow, yield stress, and other rheological properties which can be monitored.

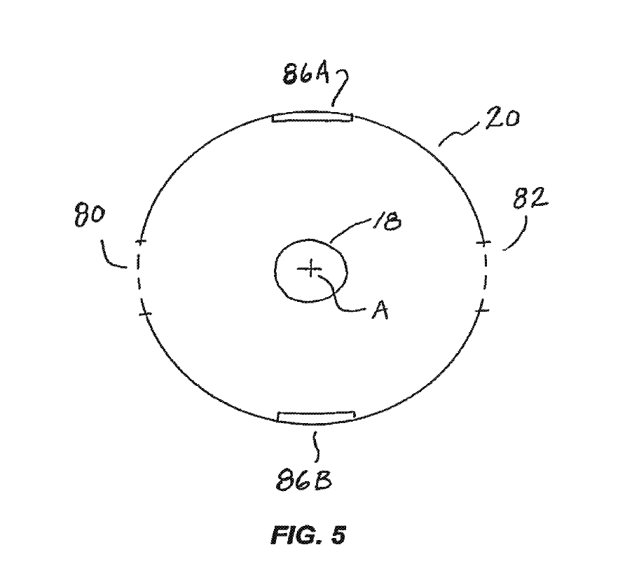

FIG. 5 is a perspective view taken along the longitudinal axis (A) of another exemplary sensor-containing body 20 of the present invention wherein one or more sensors or devices can be located within the housing of the sensor-containing body 20, and openings 80/82 in the sensor-containing body 20 admit concrete or cement within the housing for measuring or monitoring purposes. In further exemplary embodiments of the invention, a sonar emitter 86A and sonar detector 86B can be used to measure the quantity and/or quality of air voids or bubbles within concrete which is allowed to enter into the housing of the sensor-containing body 20 through one or more openings, as designated at 80 and 82. Thus, the sonar signature of a concrete mix having known air void properties can be inputted into a computer processor unit (not shown) connected to the sonar emitter and sensor 86A/86B such that the concrete can be monitored and its air properties adjusted while in transit. It is contemplated by the present inventors that sensors can be used outside as well as inside of the housing 20 for various advantages, including checking the accuracy of outside and/or inside sensors (whether for air, slump, or other properties of the concrete).

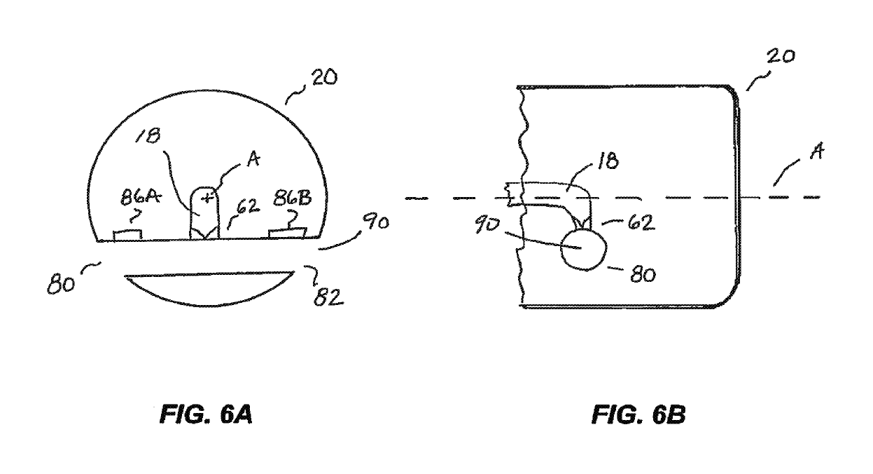

As shown in FIGS. 6A and 6B, another exemplary sensor-containing body 20 of the invention contains openings 80 and 82 (See FIG. 6A) which define between them an elongate channel 90. FIG. 6A is a diagram view taken along the axis of rotation (A) of the sensor-containing body 20; while FIG. 6B is a diagram view of the sensor-containing body 20 taken perpendicularly across the axis (A). In this embodiment, the channel is defined as a generally elongate (preferably cylindrical tube extending from one opening 80 to the other opening 82 within the sensor-containing body 20. A sonar emitter 86A is shown located along the channel at a distance from a sonar detector 86B, such that the sonar signature of concrete located within the channel 90 may be obtained, and signal from the detector 86B is conveyed by wire or wirelessly to a computer processor unit for further processing. Preferably, the channel 90 is positioned within the body housing 20 such that it is off-kilter with respect to the rotational axis (A) as shown in FIG. 6B, such that the rotational movement of the body 20 within the concrete drum will tend to force fluid concrete to flow into one of the openings 80/82 and out of the other opening. Preferably, a one-way valve 62 is located within the channel 90 to permit flushing of the channel 90 with water 32, chemical admixture 34, and/or purging liquid 38 that is introduced through a conduit/pipe (not shown) when it is desired to ensure that concrete is expelled from the channel 90 to avoiding hardening within the channel.

Devices and processes for measuring the speed of sound and/or vertical disturbances propogating in a fluid or mixture having entrained air using sonar emitters and detection devices within pipes and chambers are known. For example, U.S. Pat. No. 7,363,800 of Gysling (owned by CiDRA Corporation of Wallingford, Conn., USA) discloses an apparatus for measuring compositional parameters of solid, liquid, and gas components of a mixture flowing in a pipe.

The Gysling apparatus combines three different compositional measurements (e.g., the speed of light (microwave), the speed of sound (sonar), and mass loading of vibrating tubes or absorption of radiation) simultaneously to provide a real time, multi parameter, compositional measurement of gas-entrained mixtures. (See also U.S. Pat. No. 7,363,800, Abstract). See also U.S. Pat. Nos. 7,134,320; 7,343,820; 7,367,240; and 7,363,800 (also owned by CiDRA).

Thus, while FIG. 6A and 6B illustrate the use of sonar emitter 86A and sonar detector 86B within the sensor-containing body 20, the present inventors contemplate that a number of sensors and sensor systems may be advantageously used within the axially-located housing body 20, and particularly within a channel 90 which admits flow through of concrete from within the concrete mixer drum. For example, one or more force sensors can also be located within the channel 90.

Thus, in further exemplary systems of the invention, the sensor-containing body 20 comprises a first opening 80 and a second opening 82 defining therebetween a channel 90 for permitting concrete contained in the concrete mixer drum to flow through the channel 90, and at least one sensor for monitoring a property of the concrete within the channel. For purposes of monitoring air void quantity or quality, the system may comprise a sonar emitter 86A and a sonar detector 86B for monitoring a characteristic of concrete within the channel 90.

In other exemplary embodiments, a force sensor can be employed within a channel 90 of the housing body 20 to measure one or more properties of the concrete within the channel. For example, a capillary rheometer positioned within the channel may be used to measure pressure of concrete that flows through or is forced to flow through the channel.

It is understood that sensors of various types can be used in or in combination with the sensor-containing body 20 and axis conduit 18 of the present invention. These sensors can be connected electrically or wirelessly to one or more processor units which are in turn electrically or electronically connected to one or more memory locations, and used for program applications for monitoring the concrete (as well as the condition of the sensor-containing body 20 or other conditions within the mixer drum). The one or more processor units are also connected or electronically connected to one or more dispensing systems for administering water, chemical admixtures, or both, into a concrete mix, as generally shown in FIG. 1.

For example, the monitoring system can be used to track dosages of polycarboxylate ether cement dispersants and air control agents (air entraining and/or detraining agents) based on comparisons of real time sensor readings to past values stored in memory, and adjustments can be made by the system.

The systems of the present invention can also be used in combination with the systems described in the background section and also in this section. They can be used to deliver on-board chemical admixtures, or admixtures stored at the delivery site or onboard an admixture delivery truck. Moreover, any number of chemical admixtures and tanks (such as substitutions for tank 34 shown in FIG. 1) can be used. Chemical admixtures are added to concrete for purposes of modifying any number of properties, including, by way of example, reducing the need for water (e.g., plasticizing, increasing workability), controlling the setting of concrete (e.g., set accelerating, set retarding), managing air content and quality (e.g., air entrainers, air detrainers), shrinkage reduction, corrosion inhibition, and other properties.

In further exemplary embodiments, the conduit 18 can be used to axially house separate pipes and electrical cables, such as for separately conveying two or more of the water 32, chemical admixture 34, gas 36, and/or purging liquid 38 into drum, as well as for providing passage of one or more electrical wires from sensors to other electrical/electronic equipment which is located on the mixer truck.

In still further exemplary embodiments, the housing 20 can also contain temperature sensors, calorimetric devices, accelerometers, and other devices for measuring a property of the concrete, or for use by the processor unit to compensate for the affects of temperature, inclination and speed of the drum, and other effects.

An exemplary system of the invention for monitoring contents such as concrete within a rotable mixer drum, thus comprises: a sensor-containing body 20 which is mounted and/or rotatably positioned within and along the longitudinal rotational axis of a concrete mixer drum having a closed end and an open end, and which sensor-containing body is connected to a conduit which introduces water, chemical admixture, gas, and/or purging or cleaning fluid into the concrete mixer drum through the closed end of the drum; the sensor-containing body having at least one channel for delivering the water, chemical admixture, gas, and/or purging or cleaning fluid from the conduit and into the concrete mixer drum. In further exemplary embodiments, the sensor-containing body is mounted to an inner wall of the concrete mixer drum or to a plate mounted said inner wall at the closed end of the drum. In still further embodiments, the sensor-containing body is rotatable mounted such that it may rotate at a different rotational rate compared to the rotation of the concrete mixer drum. Preferably, at least one sensor in the sensor-containing body is a stress gauge or strain gauge, and the devices and systems of the invention may further comprise a sensor for measuring temperature or calorimetric profile of concrete contained within the drum.

Preferably, the sensor-containing body contains at least one sensor which is electrically or electronically connected to a computer processor unit which is programmed for monitoring at least one property of concrete in the mixer drum, and the computer processing unit is programmed to administer at least one of water, chemical admixture, gas, and/or purging or cleaning fluid into the concrete mixer drum through the closed end of the drum based on sensing of the concrete by the sensor-containing body. The sensor-containing body also preferably contains one-way out valves for introducing water, chemical admixture, gas, cleaning fluid, or a combination thereof into the mixer drum, while preventing ingress or blockage by the concrete or cement contained in the mixer drum.

In still further exemplary embodiments, the sensor-containing body is rotatably attached to a second body having one-way out valves for introducing water, chemical admixture, gas, cleaning fluid, or a combination thereof into the mixer drum. In other words, the sensor-containing body portion may be rotatably connected to another portion which contains the nozzles or one-way out valves used for conveying the water, chemical admixture, gas, cleaning fluid, or a combination thereof into the mixer drum.

The systems of the present invention can be used to augment existing automatic monitoring systems. For example, the present invention can be used with the system or system components used in the VERIFI LLC monitoring systems. Hence, systems of the present invention may further comprise a sensor for monitoring rotational speed of the drum, hydraulic pressure required to rotate the drum, or both. A rotational speed sensor can be used directly as one of the sensors on the sensor-containing body 20. It is also envisioned that accelerometers and various types (such as one-axis, two-axis, and three-axis accelerometers) can be used.

An exemplary method of the present invention comprises monitoring concrete using the system as previously described above.

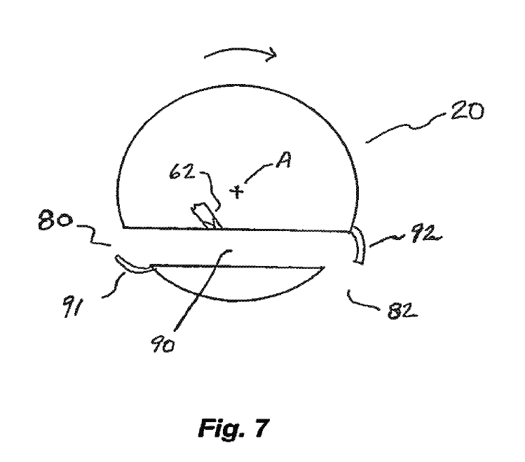

FIG. 7 illustrates a further exemplary embodiment of the invention wherein the sensor-containing body 20 comprises an intake flap, louver, or scoop 91 to facilitate the introduction of concrete into the opening 80, through the channel 90, and out of the channel 90 through a second opening 82; and, where an exit (backwards) flap, louver, or scoop 92 facilitates concrete exiting the channel 90. As previously illustrated in FIG. 6A, one or more sensors (such as a force sensor, sonar detector, or other) can be located within the channel 90 to monitor one or more properties of the concrete flowing through the channel 90, and one-way valves (such as shown at 62 in FIG. 6A) can be employed to introduce liquid or gas into the concrete. To facilitate the flow of concrete through the channel 90 and out of the opening (80), one or more one-way-valves or nozzles (shown at 62 in FIG. 7) can be angled toward one of the openings (e.g., exit opening 82) to push liquids or gas through the channel 90 toward the opening (82).

Thus, further exemplary embodiments comprise a sensor-containing body 20 having at least one flap, louver, or scoop 91 for the purpose of facilitating the flow of concrete through the channel 90 within the housing 20. A further exemplary sensor-containing housing 20 may contain at least one check valve or nozzle (shown at 62 in FIG. 7) which is effective to introduce gas and/or liquid to urge or to purge concrete within the channel 90.

In further aspects, it is not necessary that the channel 90 between the openings 80/82 be oriented in a straight shape or that the channel 90 be disposed perpendicularly with respect to the drum axis (A). It may be preferable to offset the channel 90 at an angle that is slightly less or greater than 90 degrees with respect to the drum rotational axis (A) so that fresh concrete mix rather than the concrete exiting opening 82 is scooped up at the opening 80 by the flap or scoop 91 and through the channel 90 as shown in FIG. 7. The channel 90 may be shaped to curve slightly around the drum rotational axis 7, in the manner of a bent cylinder or elongated spiral within the sensor housing body 20. Hence, in further exemplary embodiments, the sensor-containing body 20 contains at least two openings 80/82 for defining a channel 90 which may be shaped as a straight, curved, or spiraled cylinder for the passage of concrete through the housing body 20. One or more check valves 62 can be used within the channel to purge the channel of concrete periodically and at the end of a job using gas or liquids.

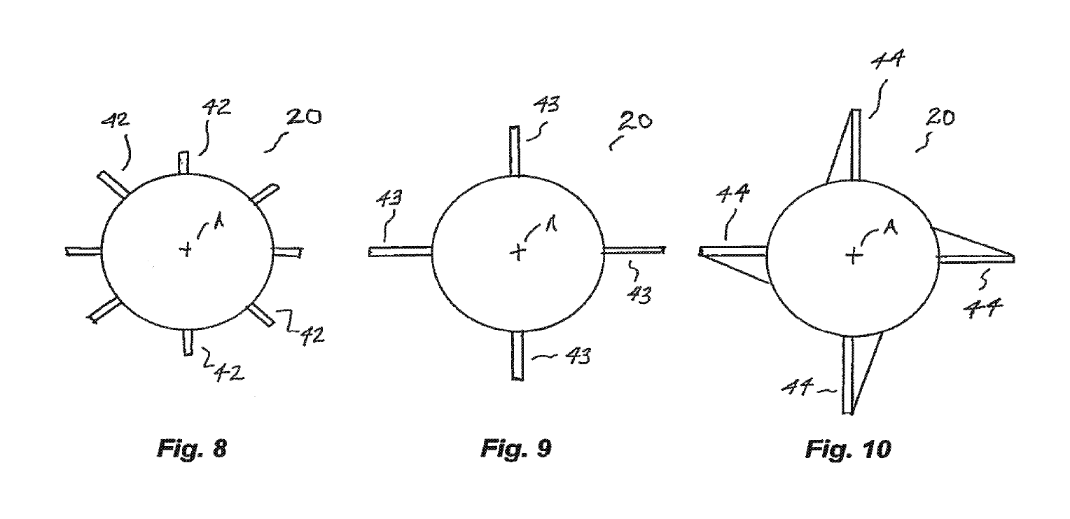

FIGS. 8-10 illustrate further exemplary sensor-containing bodies 20 having outer ribs (designated at 42 in FIG. 8), vanes or blades (designated at 43 in FIG. 9), or offset blades or flanges (designated at 44 in FIG. 10) for increasing shearing forces in the concrete. The terms “ribs,” “vanes,” “blades,” and “flanges” may be used herein interchangeably, and all of these terms denote protruding members having elongate portions which are mounted on the outside circumferential surface of the housing body 20 and extend in parallel with respect to the drum rotational axis (A) as suggested in FIGS. 8 and 9; or the blades or flanges 44 may be mounted somewhat helically or spirally (or perhaps non-parallel) with respect to the drum rotational axis (A), somewhat in the manner of a propeller, as suggested in FIG. 10.

It is preferred that the height of the ribs, vanes, blades, or flanges, from the outer circumferential surface of the housing body 10 in the direction away from the drum rotational axis, be at least three times the size of the coarse aggregate contained in the concrete mix being processed within the concrete mixer drum. It is also preferred that the protruding ribs, blades, etc., (42-44) be located evenly around the circumference of the housing body 20 and that sufficient distance be provided between adjacent protrusions 42-44 to prevent aggregates (e.g., stones) from becoming stuck or caught between the protrusions.

The ribs, vanes, blades, or flanges (42-44) as illustrated in FIGS. 8-10 may employ a stress-gauge to measure pressure of the concrete, and the strain-gauge will transmit an electrical signal to a processor unit (not shown) which can be configured or programmed to correlate the signal with a rheology property of the concrete such as slump, slump flow, yield stress, thixotropy, or other rheological property (as known in the prior art, some of which is identified in the background section). Hence, further exemplary embodiments of the invention comprise at least one protruding rib, vane, blade, or flange which incorporates a stress-gauge (e.g., eletromechanical strain-gauge) to monitor pressure of concrete shear force during rotation of the concrete mix drum or rotation of the at least one protruding rib, vane, blade, or flange within the concrete mix.

One or more check valves can be placed between the projections 42/43/44 shown in FIGS. 8-10 to purge and to clean the sensor body 20 periodically or at the end of a job.

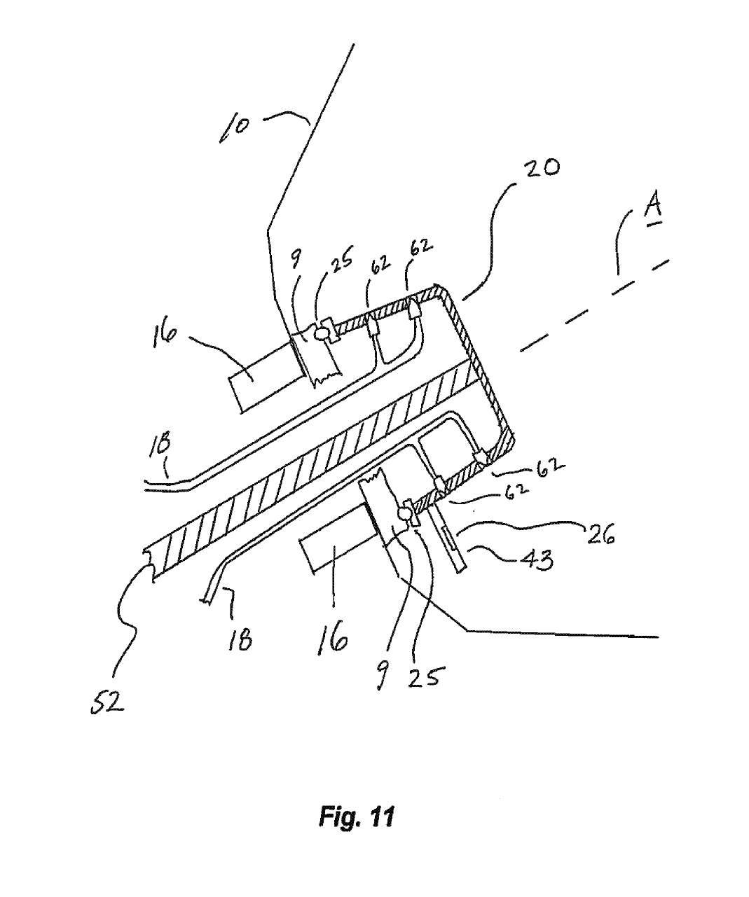

FIG. 11 illustrates another exemplary sensor-containing body 20 which mounted along the rotational axis (A) within the mixer drum 10 such that it remains relatively stationary when the mixer drum rotates around the axis. The body 20 is mounted to a strut or brace member 52 which is disposed within a channel or hole within the drum axle assembly 16 and which is mounted to a frame (not shown) of the truck or hydraulic motor housing to prevent the sensor-containing body 20 from rotating when the mixer drum 10 rotates. The strut/brace 52 is shown as a bar structure for ease of illustration, but it is preferable that a number of connective and supportive bracing structures be used along the inner walls of the housing body 20 to counter-act the forces exerted by the concrete within the mixer drum. A plate 9 is preferably used to brace the inside drum wall 1 and to provide a flat surface or groove for an annular gasket 25 which provides leak-stoppage and slidable rotating movement by the sensor-containing body 20 against the inner drum wall.

One or more sensors, such as an electromechanical strain gauge 26 (e.g., force sensor), can be mounted either on the outer surface of the housing body 20, or, as specifically illustrated in FIG. 11, on a protruding member or fin 43 (a portion of which is shown). For example, a bi-axial stress gauge may be used to measure the force of concrete in the plane of rotation and across the plane of rotation. The protruding member 43 is preferably disposed downwards in the mixer drum 10 so that it can come into contact with even small volumes of concrete mix. Again, the at least one electromechanical strain gauge 26 is electrically communicative with a processor unit (not shown) which monitors the force of the concrete (preferably at known drum rotational speed) so that a rheological property of the concrete (e.g., slump, slump flow) can be monitored and correlated with slump, and such that water and/or chemical admixtures can be dosed into the concrete mix as instructed by the processor unit. The technology for monitoring concrete mixes by analyzing electronic and/or digital signals is now the subject of numerous patents (See e.g., U.S. Pat. No. 8,118,473 of Compton et al., owned by VERIFI LLC, disclosing delivery vehicle system wherein a sensing of the rotational speed of the concrete mixer drum is used to qualify a calculation of current slump based on the hydraulic pressure required to turn the mixer drum, and flow valves and meters which could be controlled by computer to measure and control the amount of water added to the mixer drum to reach a desired slump; See also U.S. Ser. No. 12/993,844 of Berman (Publication No. US 2011/0077778 A1) which disclosed a concrete mixing control apparatus with sensor mounted on interior of a concrete mixer drum and configured to monitor stress or pressure which could be related to concrete slump, the system further comprising use of a liquid flow meter to determine amount of water needed to adjust the current slump to the target slump and then adding this amount of water.

Also shown in FIG. 11 are at least two pipes or conduits 18 for delivering gas or liquids to a number of one-way (check) valves (designated variously as at 62). For ease of illustration, the pipes 18 are shown separate and apart from the supporting brace member 52 which is used to fixedly mount the sensor-containing body housing 20, but it is expected that the supporting brace member 52 can be designed to house and to protect the pipes 18 which lead from outside the mixer drum. In further exemplary embodiments, it is preferred that the pipe 18 leading to check valves 62 located at the upper part of the housing body 20 be used for spraying liquids, such as water, chemical admixtures, drum cleaning fluid, and other liquids upwards against the inner wall of the drum. Hence, a plurality of check valves or nozzles 62 can be aimed to spray water, chemical admixture (e.g., retarder), or drum cleaner fluids against the inner wall of the drum as it rotates. This is a preferred method of the invention for introducing liquids into concrete mixes being mixed in the rotating drum, as well as for cleaning the inner wall of an empty drum at the end of a job. In still further exemplary embodiments, the check valves or nozzles 62 which are pointed downwards are preferably used for introducing gases into the concrete mix, such as carbon dioxide; and these can be very fine nozzles which can be used to entrain air and/or carbon dioxide within the concrete mix. The downwardly facing check valves or nozzles 62 can be used for introducing chemical admixtures directly into the concrete mix as well.

A particularly inventive aspect involves using the check valves or nozzles 62 for introducing liquid nitrogen directly into a concrete mix contained within the mixer drum 10.

Another inventive aspect involves using check valves on the axially-disposed sensor-containing body for injecting micro-bubbles of air into the concrete mix, such as where it is desired to obtain a lighter density concrete.

The ability to inject liquids or gases directly into the concrete mix decreases the time needed to inject these materials through the opening of the drum as well as avoids the amount of framework needed to support external pipes. In further exemplary embodiments, the pipes or conduits 18 can be heated using heating elements (not shown) or otherwise be warmed by the operation of the motor rotating the drum. These advantageously will allow water, chemical admixtures, and other fluids to be dispensed even during freezing months.

While the disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

What is claimed is:

1. A system for monitoring contents within a rotable mixer drum, comprising:
a sensor-containing body which is mounted and/or rotatably positioned within and along the longitudinal rotational axis of a concrete mixer drum having a closed end and an open end, and which sensor-containing body is connected to a conduit which introduces water, chemical admixture, liquid, gas, and/or purging or cleaning fluid into the concrete mixer drum through the closed end of the drum;
the sensor-containing body having at least one channel for delivering the water, chemical admixture, gas, and/or purging or cleaning fluid from the conduit and into the concrete mixer drum.

2. The system of claim 1 wherein the sensor-containing body is mounted to an inner wall of the concrete mixer drum or to a plate mounted said inner wall at the closed end of the drum.

3. The system of claim 1 wherein the sensor-containing body is rotatable mounted such that it may rotate at a different rotational rate compared to the rotation of the concrete mixer drum.

4. The system of claim 1 wherein at least one sensor in the sensor-containing body is a stress gauge or strain gauge.

5. The system of claim 4 wherein the sensor-containing body further comprises a sensor for measuring temperature or calorimetric profile of concrete contained within the drum.

6. The system of claim 1 wherein the sensor-containing body contains at least one sensor which is electrically or electronically connected to a computer processor unit which is programmed for monitoring at least one property of concrete in the mixer drum.

7. The system of claim 6 wherein the computer processor unit is programmed to administer at least one of water, chemical admixture, gas, and/or purging or cleaning fluid into the concrete mixer drum through the closed end of the drum based on sensing of the concrete by the sensor-containing body.

8. The system of claim 1 wherein the sensor-containing body contains one-way out valves for introducing water, chemical admixture, gas, cleaning fluid, or a combination thereof into the mixer drum.

9. The system of clam 1 wherein the sensor-containing body is rotatably attached to a second body having one-way out valves for introducing water, chemical admixture, gas, cleaning fluid, or a combination thereof into the mixer drum.

10. The system of claim 1 further comprising a sensor for monitoring rotational speed of the drum, hydraulic pressure required to rotate the drum, or both.

11. The system of claim 1 wherein the sensor-containing body contains a first opening and a second opening defining therebetween a channel for permitting concrete contained in the concrete mixer drum to flow through the channel, and at least one sensor for monitoring a property of the concrete within the channel.

12. The system of claim 11 comprising a sonar emitter and a sonar detector for monitoring a characteristic of concrete within the channel.

13. The system of claim 11 comprising at least one flap, louver, or scoop located at an opening for facilitate flow of concrete through the channel.

14. The system of claim 1 comprising at least one protruding rib, vane, blade, or flange mounted on the sensor-containing body to increase shearing force within concrete contained within the mixer drum.

15. The system of claim 14 wherein the at least one protruding rib, vane, blade, or flange incorporates a stress-gauge to monitor pressure of concrete shear force during rotation of the concrete mix drum or rotation of the at least one protruding rib, vane, blade, or flange within the concrete mix.

16. The system of claim 1 wherein the sensor-containing body is mounted to prevent rotation within the mixer drum.

17. The system of claim 16 wherein the housing body has at least two injection systems, one injection system for introducing a first liquid or gas into the mixer drum, and a second injection system for introducing a second liquid or gas into the mixer drum.

18. The system of claim 16 further comprising an elongate member having an electromechanical strain gauge for measuring a property of the concrete mix being rotated within the mixer drum.

19. The system of claim 17 wherein the liquid being introduced into the mixer drum is liquid nitrogen.

20. The system of claim 17 wherein the gas being introduced into the mixer drum is carbon dioxide.

21. A method comprising monitoring concrete using the system of claim 1.
